(19) United States
(12) Patent Application Publication
(10) Pub. No.: US 2007/0014085 A1
(43) Pub. Date: Jan. 18, 2007

(54) Mounting tray and release mechanism for a disk drive

(75) Inventors: Timothy A. Meserth, Durham, NC (US); Brian M. Kerrigan, Cary, NC (US); Kevin D. Johnson, Cary, NC (US); Charles W. Piper, Burlington, NC (US)

Correspondence Address: CARDINAL LAW GROUP, 1603 ORRINGTON AVENUE, SUITE 2000, EVANSTON, IL, 60201, US

(73) Assignee: International Business Machines Corporation, Armonk, NY (US)

(21) Appl. No.: 11/183,502

(22) Filed: Jul. 18, 2005

(51) Int. Cl. G06F 1/16

(52) U.S. Cl. 361/685

(57) ABSTRACT

A system for releasably mounting an electronic component in a computer system comprises an electronic component, a release mechanism, and a mounting tray. The electronic component includes two front and two back attachment members. The release mechanism is rotatably attached to the two back attachment members. The release mechanism includes a handle portion, an attachment portion, and at least one cam. The mounting tray is sized to receive the electronic component and rotatably attached release mechanism and includes four notches within which the electronic component attachment members are slidably received. The mounting tray further includes a latching mechanism and at least one leverage point, the leverage point being positioned to interact with the release mechanism cam.

### FIELD OF INVENTION

The present invention relates generally to electronic components. More particularly, the present invention relates to a mounting tray and release mechanism for an electronic component.

### BACKGROUND OF THE INVENTION

In computer and peripheral systems, a mounting tray is commonly used as a carrier for plugging an electronic component such as a hard disk drive into a system. Typically, the disk drive is attached to the tray using screws prior to plugging the drive into the system. Screwing the drive into the tray increases assembly time during manufacturing, and unscrewing the drive from the tray increases repair time.

In a blade computer or server, a disk drive must reside parallel with the circuit board into which it is plugged in order to conserve space. This requires that the drive be plugged into a riser card, which is plugged into the circuit board. Screwing a drive into a mounting tray before plugging the drive into a riser card is impractical, and requiring access to the sides of the tray in order to screw the drive into a mounting tray already affixed to a system limits positioning of the drive within the system. While mounting trays that do not require side screws have been proposed, these trays may not retain a disk drive securely enough for the most demanding applications.

Therefore, it is desirable to have an improved mounting tray for an electronic component, a release mechanism for an electronic component, and a system for releasably mounting an electronic component in a computer or peripheral system that overcome the aforementioned and other disadvantages.

### SUMMARY OF THE INVENTION

One aspect of the present invention is a mounting tray for an electronic module. The mounting tray comprises a base, a front wall, and two side walls. The front wall and the two side walls extend orthogonally upward from the base. A back portion of the base includes a latching mechanism. Each of the side walls includes at least one notch formed into an edge of the wall, the notch positioned to slidably receive an attachment member affixed to an electronic module.

Another aspect of the present invention is a release mechanism for releasing an electronic module from a mounting tray. The release mechanism comprises a handle portion, an attachment portion extending from the handle portion, and at least one cam extending from the attachment portion. The attachment portion includes at least one flange positioned to rotatably attach to an attachment member affixed to a back portion of an electronic module.

Yet another aspect of the present invention is a system for releasably mounting an electronic component in a computer or peripheral system. The system comprises an electronic component, a release mechanism, and a mounting tray. The electronic component includes two front and two back attachment members. The release mechanism is rotatably attached to the two back attachment members. The release mechanism includes a handle portion, an attachment portion, and at least one cam. The mounting tray is sized to receive the electronic component and rotatably attached release mechanism and includes four notches within which the electronic component attachment members are slidably received. The mounting tray further includes a latching mechanism and at least one leverage point, the leverage point being positioned to abut the release mechanism cam.

The aforementioned and other features and advantages of the invention will become further apparent from the following detailed description, read in conjunction with the accompanying drawings. The drawings are not drawn to scale. The detailed description and drawings are merely illustrative of embodiments according to the invention rather than limiting, the scope of the invention being defined by the appended claims and equivalents thereof

### BRIEF DESCRIPTION OF THE DRAWINGS

FIG. 1 is an isometric view of a mounting tray in accordance with the present invention;

FIG. 1A is an isometric view of another mounting tray in accordance with the present invention;

FIG. 2 is an isometric view of a release mechanism in accordance with the present invention;

FIG. 3A is an isometric view of a system for releasably mounting an electronic component in a computer or peripheral system in accordance with the present invention, the system being shown with the electronic component retained within a mounting tray; and

FIG. 3B is an isometric view of the system of FIG. 3A, the system being shown with the electronic component released from the mounting tray.

Like reference numbers are used throughout the drawings to refer to like elements.

### DETAILED DESCRIPTION OF THE PRESENTLY PREFERRED EMBODIMENTS

The present invention is described hereinafter with reference to the accompanying figures, in which preferred embodiments are shown. The invention may, however, be embodied in many different forms and should not be construed as limited to the embodiments set forth herein.

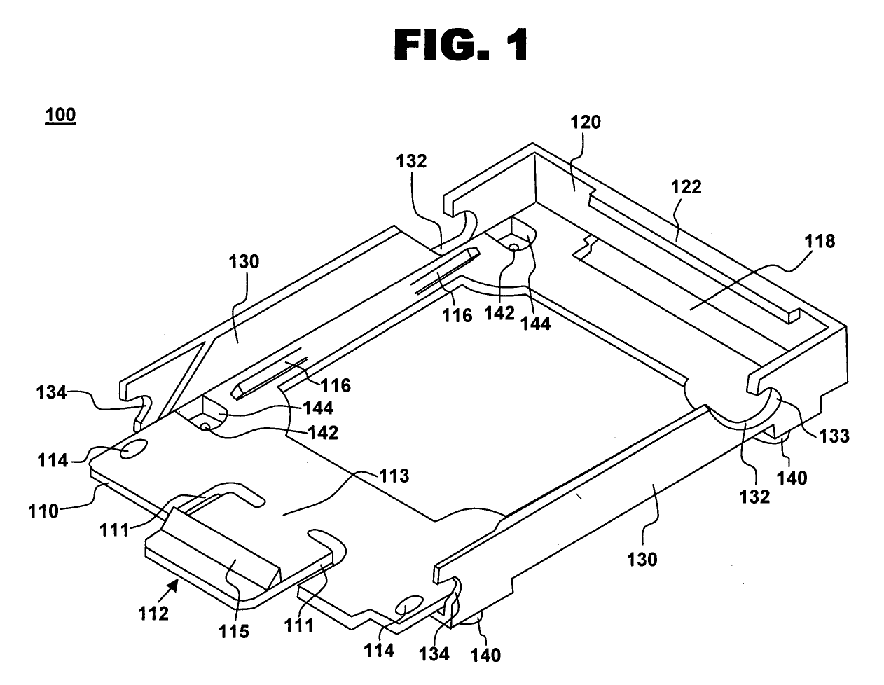

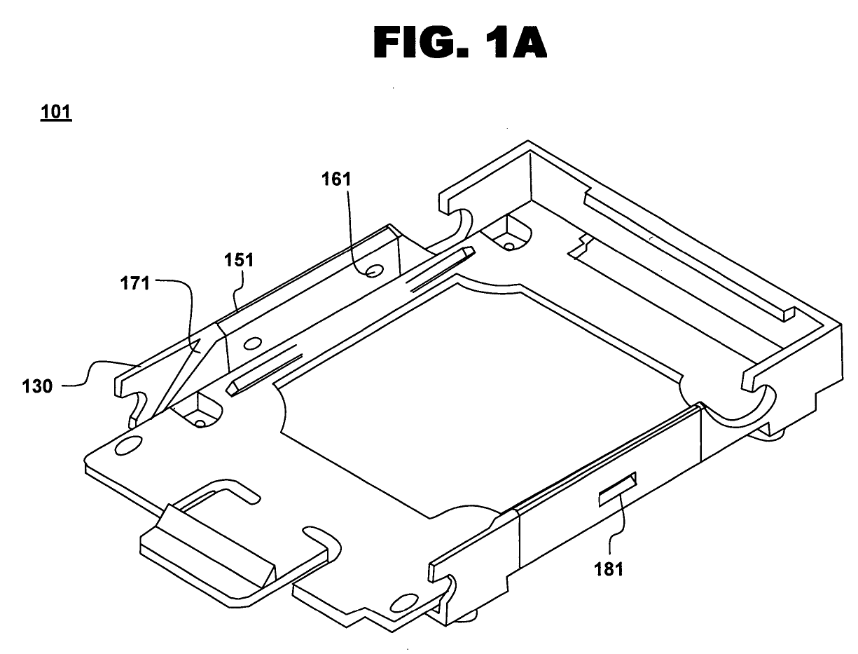

One aspect of the present invention is a mounting tray for an electronic module. One embodiment of the device, in accordance with the present invention, is illustrated in FIG. 1 at 100. As illustrated, mounting tray 100 comprises a base 110, a front wall 120, and two side walls 130. Base 110 includes a latching mechanism 112, two leverage points 114 for cams, and four leaf springs 116. Base 110 further includes an opening 118 to accommodate a riser card. Each side wall 130 includes an angled notch 132 and a rounded notch 134. In one embodiment, illustrated in FIG. 1A, side wall 130 tapers 171 from the intersection with the base 110 to a side of the side wall 130 opposite the base. Such a taper 171 can be termed an angled lead-in and assists in self guidance for hard disk drive installation, for example.

Mounting tray 100 comprises a molded polycarbonate/ABS alloy. Other materials may be used to form the tray. For example, the tray may also be die cut from a metal such as stainless steel or may include molded polyester polymer portions as well as metal portions.

Both latching mechanism 112 and leverage points 114 are formed into a back portion of tray base 110. Latching mechanism 112 is an integral part of tray base 110 that is partially delineated by two channels 111 passing along the sides and front of the mechanism, leaving a relatively narrow bridge of material 113 attaching the front of latching mechanism 112 to tray base 110. The narrowness of the bridge allows latching mechanism 112 to flex with respect to tray base 110. Latching mechanism 112 includes a wall 115 set in from the back edge of latching mechanism 112. Wall 115 extends upward to engage the back end of an electronic module seated in tray 110, thereby locking the module into tray 100. Applying a downward pressure to a back portion of latching mechanism 112 flexes wall 115 away from the back of the electronic module, allowing the electronic module to be removed from tray 100.

Two leverage points 114 for a cam are formed into a back portion of tray base 110, one on either side of the back portion. In the illustrated embodiment, leverage points 114 are indentations in tray base 110. One skilled in the art will appreciate that the size and shape of a leverage point may vary depending on the size and shape of the cam with which the leverage point is designed to interact. The number of leverage points included in tray base 110 may also vary depending on the number of cams that are intended to interact with the base.

Four leaf springs 116 are attached to tray base 110 by being formed into the base. Only two leaf springs 116 are visible in FIG. 1, the other two being hidden behind a side wall 130. The leaf springs press against the bottom surface of an electronic component seated in tray 100, the resilience of the springs attenuating or eliminating rotational vibration of the electronic component within the tray. One skilled in the art will appreciate that the number of leaf springs may be varied. In addition, another vibration dampening element may be used in place of the leaf springs. For example, other types of springs may be formed into the tray base or attached onto the tray base surface, or a resilient material may be attached to the tray base surface in one or more locations.

Tray base 110 includes an opening 118 sized to receive a riser card. The riser card allows an electronic component seated in tray 100 to be plugged into a circuit board with tray 100 positioned parallel with the circuit board.

Front wall 120 of tray 100 extends orthogonally upward from tray base 110. Front wall 120 includes a shelf 122 to support a top portion of a riser card received within tray base opening 118.

Two side walls 130 extend orthogonally upward from tray base 110, with the front edge of each side wall 130 connecting with front wall 120. Each side wall includes an angled notch 132 formed into a top edge of the wall and a rounded notch 134 formed into the free back edge of the wall. Each angled notch 132 has a rounded forward portion 133 that is similar or identical in shape to rounded notch 134.

The two angled notches 132 are positioned to slidably receive attachment members affixed to a front portion of an electronic module (front attachment members), while the two rounded notches 134 are positioned to slidably receive attachment members affixed to a back portion of the electronic module (back attachment members). The attachment members are, for example, screws; and the electronic module to which the screws are affixed is, for example, a hard disk drive. By convention, hard disk drives are a standard length and width but may vary in thickness. In keeping with the convention, screw holes for mounting a hard disk drive are positioned at the same locations with reference to the front and back ends of the drive and with reference to the bottom surface of the drive. Thus, screws affixed to any conventional hard disk drive will align with notches 132 and 134 of tray 100.

The shape of angled notches 132 aids in directing front attachment members downward and forward into the rounded forward portions of the notches, where the attachment members are retained. Back attachment members slide directly into rounded notches 134 as the front attachment members enter the rounded forward portions of notches 132. The back attachment members are retained within rounded notches 134, just as the front attachment members are retained within the rounded portions of angled notches 132.

Tray 100 may include legs 140 to raise tray 100 above a circuit board or other surface upon which the tray rests. Tray 100 is affixed to the circuit board or other surface by means of screws or other attachment members that pass through openings 142 inset in recesses 144.

FIG. 1A illustrates another embodiment of tray 101 featuring at least one clip 151 attached to side wall 130. Clip 151 comprises a metallic material, in one embodiment. In another embodiment, clip 151 comprises an elastomeric material. Clip 151 is configured for snap-in attachment to side wall 130 in one embodiment. In the embodiment illustrated in FIG. 1A, dimples 161 press against a side surface of the housing of the hard disc drive to maintain positioning.

Clip 151 is configured to provide additional rotational vibration dampening for standard drives (i.e., non-flash), and can be removed from the tray to support a flash drive. In one embodiment, clip 151 features a hole 181 configured to mate with a hole on side wall 130 to illustrate a fit. In one embodiment, hole 181 is configured to affix an inserted hard disk drive with the tray 101.

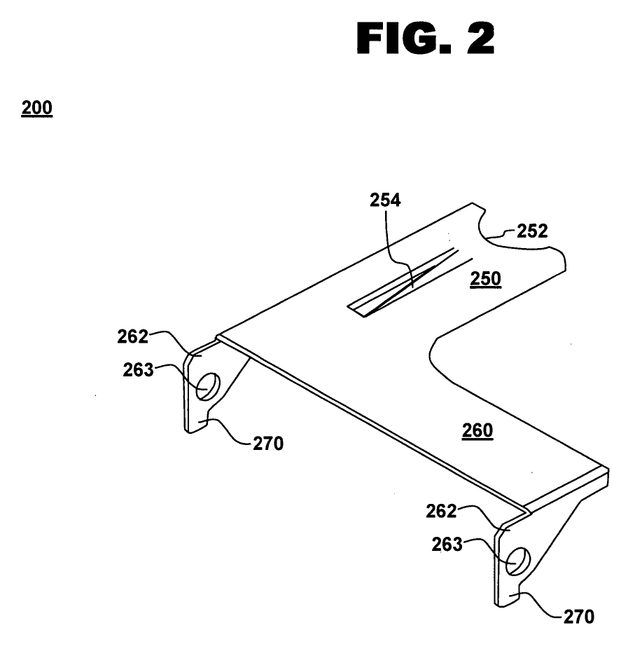

Another aspect of the present invention is a release mechanism for releasing an electronic module from a mounting tray. One embodiment of a release mechanism according to the present invention is illustrated in FIG. 2 at 200. Release mechanism 200 comprises a handle portion 250, an attachment portion 260, and two cams 270. Attachment portion 260 includes two flanges 262. The release mechanism illustrated in FIG. 2 is designed to interact with the mounting tray illustrated in FIG. 1 and described above. However, a release mechanism in accordance with the present invention may be used with other mounting trays and is not limited to use with the mounting tray of FIG. 1.

Release mechanism 200 comprises a molded polycarbonate/ABS alloy. Other materials may be used to form the mechanism. For example, the mechanism may also be die cut from a metal such as stainless steel or may include molded polyester polymer portions as well as metal portions.

In the illustrated embodiment, handle portion 250 is elongated and includes a recess 252 to provide finger access for ease of rotating the free end of handle portion 250 up and away from the surface of an electronic module to which the release mechanism is attached. An appendage 254 extends downward from the handle portion to position the handle portion above the surface of an electronic module.

Attachment portion 260 extends from handle portion 250, the two portions forming an integral whole. Attachment portion 260 includes two flanges 262 positioned to rotatably attach to attachment members affixed to a back portion of an electronic module. For example, the attachment members may be screws affixed to a back portion of a hard disk drive, with one screw affixed to each side of the drive. In this example, one flange 262 is rotatably attached to each screw. Each flange 262 includes an opening 263 to receive the screw or another attachment member. In another embodiment, the attachment portion may include a single flange, with that flange attached to a single attachment member.

As illustrated in FIG. 2, a cam 270 extends from an edge of each flange 262. One skilled in the art will appreciate that the number and positioning of the cams may be varied. For example, an attachment portion according to the present invention may include two flanges with a single cam extending from an edge of one of the flanges or may include a single flange with a single cam extending from an edge of that flange, or one or more cams may extend from a position on the attachment portion other than from an edge of a flange.

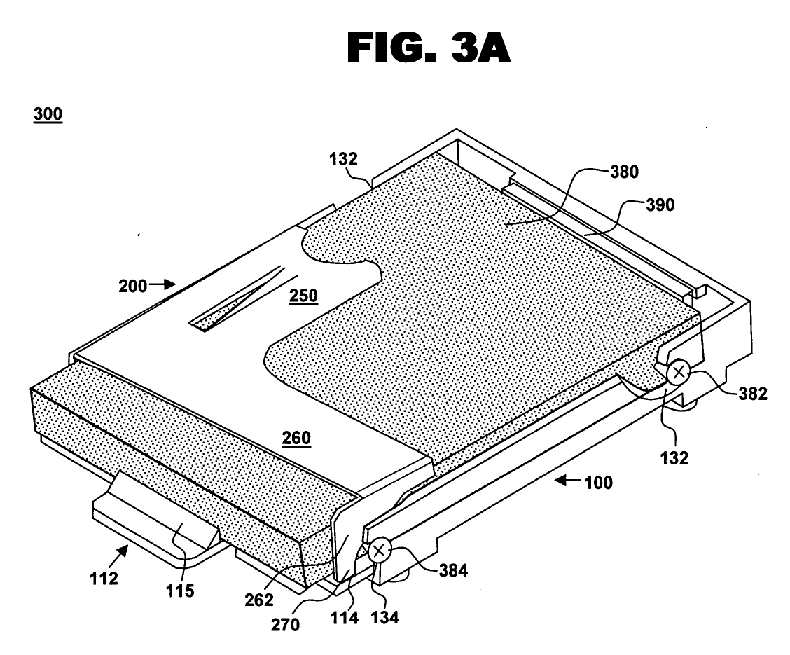

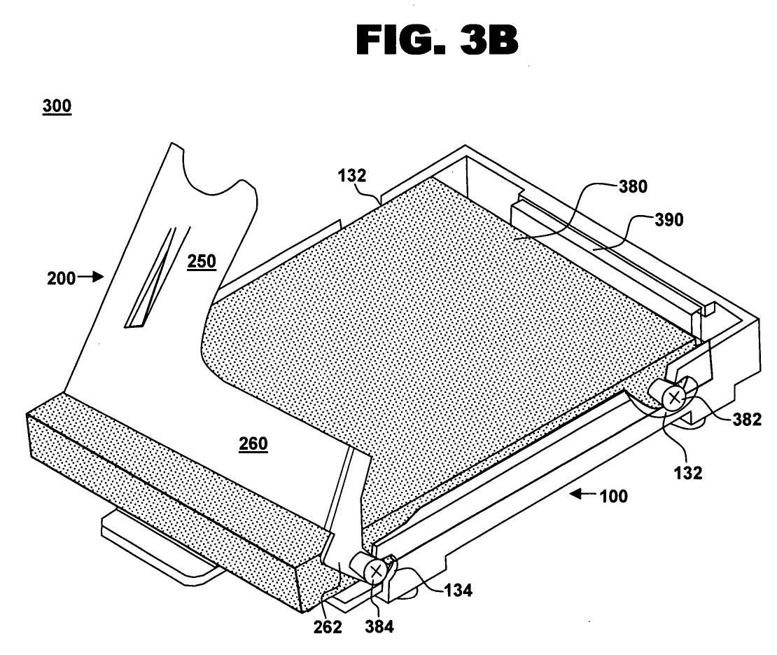

Yet another aspect of the present invention is a system for releasably mounting an electronic component in a computer or peripheral system, comprising an electronic component, a release mechanism, and a mounting tray. In one embodiment according to the present invention, illustrated in FIGS. 3A and 3B at 300, the mounting tray is mounting tray 100, illustrated in FIG. 1 and described above, and the release mechanism is release mechanism 200, illustrated in FIG. 2 and described above. The electronic component 380 is a hard disk drive. One skilled in the art will appreciate that a system according to the present invention may include an electronic component other than a hard disk drive.

Hard disk drive 380 may be, for example, a magnetic disk drive, a flash disk drive, an optical disk drive, and the like. Hard disk drive 380 includes two front attachment members and two back attachment members. In the illustrated embodiment, the attachment members are front screws 382 and back screws 384 affixed to hard disk drive 380 on either side of the drive at locations standard in the industry for mounting a hard disk drive.

Release mechanism 200 is rotatably attached to the two back screws 384 of hard disk drive 380. As seen in FIG. 2 as well as in FIGS. 3A and 3B, release mechanism 200 includes handle portion 250 and attachment portion 260. Attachment portion 260 includes two flanges 262. One flange 262 is attached to each back attachment member 384.

Mounting tray 100 is sized to receive hard disk drive 380 and the rotatably attached release mechanism 200. Mounting tray 100 includes an opening 118 (seen in FIG. 1) to receive a riser card 390, allowing mounting tray 100 and hard disk drive 380 to be positioned parallel with a circuit board. Mounting tray 100 is affixed to a circuit board prior to inserting hard disk drive 380 into the tray, using screws or other attachment members that pass through openings 142 and are inset in recesses 144 (seen in FIG. 1)

Hard disk drive 380 slides into mounting tray 100 from above and slightly forward of the tray, with screws 382 and 384 and release mechanism 200 already affixed to hard disk drive 380. For insertion of hard disk drive 380 into mounting tray 100, handle portion 250 of release mechanism 200 is positioned as seen in FIG. 3A, parallel with and resting on the top surface of hard disk drive 380. Mounting tray 100 includes four notches: two angled notches 132 and two rounded notches 134. Front screws 382 are slidably received within angled notches 132, while back screws 384 are slidably received within rounded notches 134. The shape of angled notches 132 guides front screws 382 down and into notches 132 and aids in positioning back screws 384 to slide forward into rounded notches 134. Once screws 382 and 384 have been slid into notches 132 and 134, respectively, the notches retain the screws as shown in FIG. 3A.

Mounting tray 100 includes latching mechanism 112, which releasably engages a back end of hard disk drive 380 when the drive is seated in the tray. As can be seen in FIG. 3A, wall 115 of latching mechanism 112 extends upward behind hard disk drive 380 once screws 382 and 384 have been slid into notches 132 and 134, preventing hard disk drive 380 from sliding back out of mounting tray 100. To remove hard disk drive 380 from mounting tray 100, latching mechanism 112 is depressed to flex wall 115 away from hard disk drive 380, disengaging latching mechanism 112 and releasing hard disk drive 380.

Mounting tray 100 also includes a vibration dampening element, leaf springs 116 (illustrated in FIG. 1). Leaf springs 116 press against the bottom surface of hard disk drive 380 when it is seated in mounting tray 100, attenuating or eliminating rotational vibration of the drive within the tray.

The combination of screws 382 and 384 being retained within notches 132 and 134, latching mechanism 112 engaging a back end of hard disk drive 380, and leaf springs 116 pressing against the bottom surface of hard disk drive 380 holds the drive securely within mounting tray 100. Because hard disk drive 380 slides into mounting tray 100 from the top and front and is automatically retained within the tray, system 300 may be placed in positions within a computer or other system that provide no side access to the tray. For example, system 300 may be positioned in a corner of a case, or multiple systems according to the present invention may be positioned side by side. And because release member 200 only minimally increases the height of the system, system 300 may be used in an environment such as that presented by a blade computer where a minimum profile is required.

Release member 200 allows hard disk drive 380 to be easily removed from mounting tray 100 once latching mechanism 112 has been disengaged, even when the tray is mounted in a corner or another comparatively inaccessible location. Release member 200 not only provides a handle, handle portion 250, which can be gripped to lift hard disk drive 380 out of mounting tray 100, release member 200 also interacts with mounting tray 100 to provide a mechanical advantage when removing hard disk drive 380 from mounting tray 100.

As is best seen in FIG. 2, release member 200 includes two cams 270 extending from the edges of flanges 262. As seen in FIG. 1, mounting tray 100 includes two leverage points 114 formed into a back portion of tray base 110 and positioned to abut cams 270. When release member 200 is oriented as seen in FIG. 3A, cams 270 rest above leverage points 114. Rotating the front end of handle portion 250 up and away from hard disk drive 380 rotates cams 270, causing the cams to strike leverage points 114, translating the rotational motion of cams 270 into a linear motion that moves hard disk drive 380 backward with respect to mounting tray 100, releasing screws 382 and 384 from notches 132 and 134, respectively, as seen in FIG. 3B.

In practice, the present invention provides a system that offers improved ease of use. An electronic component may be slid into a mounting tray and retained within the tray with no need to take any further actions to retain the component within the tray. The component may be easily removed from the tray by depressing a latching mechanism and rotating a release mechanism. This can be accomplished using one hand, with the thumb used to depress the latching mechanism and the fingers used to lift and rotate the release mechanism. The system may be positioned in relatively inaccessible locations, providing increased freedom for packaging design in addition to its improved ease of use.

While the embodiments of the present invention disclosed herein are presently considered to be preferred embodiments, various changes and modifications can be made without departing from the spirit and scope of the present invention. The scope of the invention is indicated in the appended claims, and all changes that come within the meaning and range of equivalents are intended to be embraced therein.

What is claimed is:

1. A mounting tray for an electronic module, comprising:
a base, a back portion of the base including a latching mechanism;
a front wall extending orthogonally upward from the base; and
two side walls extending orthogonally upward from the base, each side wall including at least one notch formed into an edge of the wall, the notch positioned to slidably receive an attachment member affixed to an electronic module.

2. The mounting tray of claim 1 wherein the base includes at least one vibration dampening element.

3. The mounting tray of claim 2 wherein the vibration dampening element comprises a plurality of leaf springs attached to the base.

4. The mounting tray of claim 1 wherein the base includes an opening sized to receive a riser card.

5. The mounting tray of claim 1 wherein the base includes at least one leverage point for a cam.

6. The mounting tray of claim 5 wherein the leverage point for the cam is an indentation in the base.

7. The mounting tray of claim 1 wherein each side wall includes an angled notch formed into a top edge of the wall and a rounded notch formed into a back edge of the wall, and wherein the angled notch is positioned to slidably receive a first attachment member affixed to a front portion of an electronic module and the rounded notch is positioned to slidably receive a second attachment member affixed to a back portion of the electronic module.

8. The mounting tray of claim 1 wherein the tray comprises a polycarbonate/ABS alloy.

9. The mounting tray of claim 1 further comprising:
a plurality of legs extending downward from the base.

10. A release mechanism for releasing an electronic module from a mounting tray, comprising:
a handle portion;
an attachment portion extending from the handle portion, the attachment portion including at least one flange positioned to rotatably attach to an attachment member affixed to a back portion of an electronic module; and
at least one cam extending from the attachment portion.

11. The release mechanism of claim 10 wherein the handle portion includes a recess to provide finger access.

12. The release mechanism of claim 10 wherein the handle portion includes an appendage to position the handle portion above the surface of an electronic module.

13. The release mechanism of claim 10 wherein the cam extends from an edge of the flange.

14. The release mechanism of claim 10 wherein the attachment portion includes two flanges, and wherein a cam extends from an edge of each flange.

15. An electronic system comprising:
an electronic component including two front attachment members and two back attachment members;
a release mechanism rotatably attached to the two back attachment members, the release mechanism including a handle portion, an attachment portion, and at least one cam; and
a mounting tray sized to receive the electronic component and rotatably attached release mechanism, the mounting tray including four notches for slidably receiving the electronic component attachment members, the mounting tray further including a latching mechanism and at least one leverage point, the leverage point positioned to abut the release mechanism cam.

16. The system of claim 15 wherein the electronic component is selected from the group consisting of a magnetic disk drive, a flash disk drive, and an optical disk drive.

17. The system of claim 15 wherein the electronic component attachment members are screws.

18. The system of claim 15 wherein rotating a front end of the release mechanism handle portion away from the electronic component moves the electronic component upward and backward with respect to the mounting tray.

19. The system of claim 15 wherein the release mechanism attachment portion includes at least one flange.

20. The system of claim 19 wherein the release mechanism cam extends from an edge of the flange.
